(19) United States
(12) Patent Application Publication
(10) Pub. No.: US 2024/0219249 A1
(43) Pub. Date: Jul. 4, 2024

(54) SWING TORQUE SENSING AND TRANSMITTING DEVICE

(71) Applicant: CHINA PNEUMATIC CORPORATION, Taoyuan City (TW)

(72) Inventor: DERRICK CHU, Taoyuan City (TW)

(21) Appl. No.: 18/091,401

(22) Filed: Dec. 30, 2022

(51) Int. Cl. G01L 3/10; G01L 25/00

(52) U.S. Cl. CPC G01L 3/108; G01L 25/003

(57) ABSTRACT

A swing torque sensing and transmitting device, flexibly mounted between the grip of a torque tool and the drive head of a bolt or nut, includes a sensing shaft, a torque sensing unit, a battery cover plate, two outer housings, a circuit board module and a battery module. A battery cover plate holds the battery module inside a housing. The circuit board module is set in another housing. The device is swinging in the process of tightening or un-tightening the threaded fastener, by sensing the deformation sensing signal caused by the body bending due to pushing or pulling, which is amplified by the circuit board module, and continuously calculates the applied torque and angular movement of the device, and when the target torque or angle displacement is reached, an audible and visual warning is given while the result is displayed, recorded or uploaded at the same time.

### BACKGROUND OF THE INVENTION

### 1. Field of the Invention

The present disclosure relates to a swing torque sensing and transmitting device, and in particular to a device fitted between the grip and various drive heads of an interchangeable-head torque wrench to sense and transmit the fastening torque and angular displacement and thereby enhance use flexibility.

### 2. Description of the Related Art

A conventional digital display-style torque wrench has a grip which a torque sensing component, such as a strain gauge, is attached and fixed to. When subjected to a force, the strain gauge deforms and undergoes a change in resistance, thereby sensing the strength of a torque produced by the wrench. Therefore, the torque sensing component enables users of the conventional digital display-style torque wrench to control and determine the strength of the fastening torque of a threaded fastener.

However, in addition to its high production cost, the digital display-style torque wrench is disadvantaged by its non-changeable rotating drive head. To carry out different types of fastening processes, the users have to purchase other types of hand tools capable of measuring a torque and thus incur expenses. The aforesaid disadvantages give rise to torque wrenches with changeable drive heads whereby the users using the same grip of a torque wrench with a changeable drive head are able to change the drive head to meet the need for the fastening processes. The grips of some torque wrenches with changeable drive heads are even capable of performing digital torque sensing and display. However, only one type of drive heads with a corresponding “fitting structure” can be for use with the grip of every type of torque wrenches with changeable drive heads, and yet the cost of the torque wrenches with changeable drive heads remains high.

The commercially-available torque wrenches with changeable drive heads not only come with a wide variety of fitting structures of the drive head and the grip but also remain expensive. Furthermore, given the trend toward Industry 4.0 and Industrial Internet of Things (IIOT), an increasingly large number of fastening processes of manually-operated torque wrenches require recording data about an applied torque, thereby rendering the wrenches capable of performing digital torque display seemingly the only choice.

The conventional torque sensing and transmitting device is usually built-in in the body of a torque tool or connected to various rotary torque transducers at the force-applying end of the torque tool to detect the deformation of the “rotating” sensing shaft because of a “bend” thereof under a force. Alternatively, a sensing component, such as a strain gauge, is attached and fixed to a fixed position on the grip of a digital display-style wrench to detect the deformation of the sensing shaft because of a “bend” thereof under a pushing force or a pulling force. The deformation is employed in computation of a torque, and an angular displacement is computed with a gyroscope.

The changeable drive heads of commercially-available digital display-style torque wrenches are only suitable for use with the grips of the wrenches when the fitting structure of the force-applying end of the grips corresponds in shape and dimensions to the fitting structure of the drive heads.

Both conventional digital display-style wrenches and conventional torque wrenches that have changeable drive heads and can perform digital display are characterized in that their torque sensing component devices are fixed to their grips.

Torque wrenches with changeable drive heads are torque tools manually operated to swing and thereby fasten or loosen a threaded fastener (for example, a bolt or a nut) and are exemplified by dial-style, pointer-style, fine-tuning-style or click sound-style conventional torque wrenches or digital display-style torque wrenches. They use identical grips but change drive heads with identical “fitting structures” but different shapes according to the need for fastening processes.

As for torque wrenches with changeable drive heads, typical fitting structures have cross sections that are dovetail-shaped, in round shape, in rectangular shape, and in other special shapes, are produced in the form of male-female hybrid structures, and are equipped with a positioning and orientation mechanism conducive to aligned engagement and aligned direction of force exertion during an assembly process.

After the torque sensing devices have changed the drive heads, they vary in the distance between the torque sensing component attached and fixed to the grip of the torque tool and the rotational center of a bolt or nut driven by the drive head changed, and in the computed torque and angle. Before use, the users have to perform calibration with a torque meter and an angle gauge to obtain related numerical values to the detriment of simple operation and time efficiency.

### BRIEF SUMMARY OF THE INVENTION

In view of the aforesaid drawbacks of the prior art, it is an objective of the disclosure to provide a swing torque sensing and transmitting device that can be modularized and thereby adapted to pluggably connect the grip and a selected drive head according to variation in the texture and dimensions of a sensing shaft and variation in the fitting structures of an output end and an input end of the sensing shaft within a specific torque sensing range to enable all torque wrenches with changeable drive heads to turn into wrenches capable of performing torque sensing and display, so as to widen the choices of the types of drive heads available for use with the swing torque sensing and transmitting device of the disclosure, enhance use flexibility and convenience, and greatly enhance the quality of assembly operation.

The swing torque sensing and transmitting device of the disclosure computes the strength of an applied torque according to the linear relation between a deformation sensing value generated in response to the “bend” of the sensing shaft under a force within its yield strength range and a generated torque value.

The fitting structures of the two ends of the sensing shaft of the device of the disclosure form male-female adapting mechanisms which are identical or different in dimensions and shapes so that the swing torque sensing and transmitting device can be pluggably mounted between the grip and the drive head with different fitting structures to enhance use flexibility.

The device of the disclosure is pluggably inserted between the grip and the drive head of a torque tool with identical fitting structures and even different fitting structures to enhance use flexibility.

The device of the disclosure is applicable to commercially-available drive heads sold under different brands. Its input ends have fitting structures which differ in cross-sectional shape, for example, hexagonal, polygonal, opened, and square, to enable a change in direction.

The device of the disclosure is capable of undergoing modularization. The device has different torque sensing capability ranges because of variation in the texture and rigidity of the sensing shaft enclosed by the outer housings of the same dimensions. The device uses identical torque sensing components, circuit board modules and power modules and only requires the input end and the output end of the sensing shaft to have fitting structures corresponding in shapes and dimensions to the grip or drive head to connect to.

The device of the disclosure is also advantageous in that the two ends of the sensing shaft form a snap-engagement mechanism so as to be conveniently pluggably engaged with head adapting devices of different shapes and dimensions and thus fitted between the grip and the drive head with different fitting structures, thereby enhancing use flexibility.

In conclusion, the swing torque sensing and transmitting device of the disclosure can be mounted between the grip and the drive head of any torque wrenches equipped with changeable drive heads and sold under different brands to enhance use flexibility. The device of the disclosure can function as a torque wrench capable of performing digital torque sensing and display. Furthermore, the device of the disclosure can be mounted between the grip with one type of fitting structure and the drive head with another type of fitting structure because of variation in the shapes and dimensions of the input end and the output end of the sensing shaft. Furthermore, the device of the disclosure can undergo modularization to effectively reduce inventory in terms of types of goods and reduce production cost, thereby greatly enhancing the ease of the fastening processes. In addition, the device of the disclosure allows the users to enter or scan the code numbers of the grip and the drive head of the tool to use and calibrate the torque and angle beforehand so that the users only need to enter related code numbers in order to fetch operation parameters of a combination of the grip and the drive head of the tool and start operation. The device of the disclosure is capable of implementing data transmission and access wired or wirelessly to promote the industrial applicability of the device of disclosure.

In order to achieve the above and other objectives, the disclosure provides a swing torque sensing and transmitting device comprising a sensing shaft, a torque sensing unit, a first outer housing, a second outer housing, a circuit board module, a battery cover plate and a battery module. The first outer housing and the second outer housing are made of a metallic or non-metallic material. The sensing shaft is made of a metallic or non-metallic material that varies in texture and rigidity to effectuate different torque sensing ranges. The battery cover plate fixes the battery module to inside the second outer housing. The circuit board module is disposed in the first outer housing. The device of the disclosure is detachably fitted between a grip and a drive head with identical or different fitting structures to enhance use flexibility. While the device is swinging to tighten or loosen a threaded fastener, such as a bolt or nut, a deformation sensing signal is generated by the torque sensing unit because of a bend of the sensing shaft under a pushing or a pulling force, amplified and instantly calculated by the circuit board module. When the target torque or angular displacement is attained, the device determines whether the target torque or angular displacement falls within the range of predetermined precision tolerance, emits a sound or indicator light as an alert, and displays, stores or uploads the data. Therefore, the device of the disclosure enables all conventional swing torque wrenches for use in fastening to function as digital display wrenches and carry out assembly processes smartly with bolts.

In order to achieve the above and other objectives, the disclosure further provides a method of modularizing a swing torque sensing and transmitting device, wherein the sensing portion of the sensing shaft enclosed by the outer housings of the same dimensions is of different dimensions and variable in texture and rigidity to provide different torque sensing ranges, allowing a grip and a drive head of a torque tool to be fitted to and engaged with the input end and the output end of the sensing shaft, respectively, wherein the shapes and dimensions of the input end and the output end are designed according to the “fitting structures” of the grip and the drive head.

In an embodiment, the shapes and dimensions of the input end of the sensing shaft of the device of the disclosure are designed according to the structure of the force-applying end structure of the grip, and the shapes and dimensions of the output end of the sensing shaft of the device of the disclosure are designed according to the structure of the input end of the drive head selected.

In an embodiment, the input end and the output end of the sensing shaft of the device of the disclosure are dovetail-shaped, in round shape, in rectangular shape, in hexagonal shape, or in any special shape.

In an embodiment, the input end and the output end of the sensing shaft of the device of the disclosure differ in shapes and dimensions. For example, the input end has a round cross section, and the output end corresponds in shape to the cuboid drive head, thereby facilitate the use of a drive head with a cuboid fitting structure.

In an embodiment, the torque sensing unit is attached to the sensing shaft in a force-bearing direction thereof, electrically connected to the circuit board module, and thus adapted to send to the circuit board module the deformation sensing signal generated in response to a bend of the sensing shaft under a force.

In an embodiment, the axis of the sensing shaft of the device of the disclosure and the rotational axis of a sleeve and a threaded fastener to fasten in place are not collinear.

In an embodiment, the torque sensing unit is any component capable of sensing deformation, such as a resistance strain gauge, a piezoelectric strain gauge or similarly functioning sensing elements.

In an embodiment, the circuit board module comprises a microprocessor, a signal amplification unit, a transmission unit, a power circuit unit, a gyroscope, an output/input unit, a memory unit, an alert unit and a display unit.

In an embodiment, the output/input unit of the circuit board module is a USB for outputting or inputting signals or inputting power.

In an embodiment, the circuit board module comprises a gyroscope for computing an angular displacement.

In an embodiment, the circuit board module comprises a power circuit unit, such as a charging circuit and a power switch.

In an embodiment, the circuit board module comprises an output/input unit, such as Type C and UART. UART adopts wired output.

In an embodiment, the circuit board module comprises a transmission unit, such as RF/BT/WIFI, antenna.

In an embodiment, the circuit board module comprises a memory unit for recording code numbers of the grip and the drive head and calibration parameters.

In an embodiment, the circuit board module comprises a display unit electrically connected to the circuit board module or enables real-time display on peripherally-located smartphones, tablets, laptops or wearable devices via the transmission unit wired or wirelessly

In an embodiment, the circuit board module comprises an alert unit, such as an LED indicator and a buzzer.

In an embodiment, the battery module is disposed in the second outer housing, fixed in place with bolts and the battery cover plate, and electrically connected to the circuit board module.

Embodiments of the swing torque sensing and transmitting device of the disclosure are depicted by the accompanying drawings and described below. To facilitate comprehension, identical components in the embodiments below are denoted with identical reference numerals.

### BRIEF DESCRIPTION OF THE DRAWINGS

FIG. 1 is a first schematic perspective view of the swing torque sensing and transmitting device of the disclosure.

FIG. 2 is a second schematic perspective view of the swing torque sensing and transmitting device of the disclosure.

FIG. 3 is a schematic view of FIG. 2 viewed from right side.

FIG. 4 is a schematic exploded view of the swing torque sensing and transmitting device of FIG. 1.

FIG. 5 is a schematic cross-sectional view of the swing torque sensing and transmitting device of FIG. 1.

FIG. 6 is a schematic view of a circuit board module of the swing torque sensing and transmitting device of the disclosure.

FIG. 7 is a schematic exploded view of modularization of the swing torque sensing and transmitting device of the disclosure.

FIG. 8 is a schematic perspective view of the swing torque sensing and transmitting device of FIG. 7.

FIG. 9 is a first schematic view of the swing torque sensing and transmitting device 1A shown in FIG. 8 and mounted between the grip and the drive head, with their fitting structures corresponding to each other.

FIG. 10 is a second schematic view of the swing torque sensing and transmitting device 1B shown in FIG. 8 and mounted between the grip and the drive head, with their fitting structures corresponding to each other.

FIG. 11 is a third schematic view of the swing torque sensing and transmitting device 1C shown in FIG. 8 and mounted between the grip and the drive head, with their fitting structures corresponding to each other.

FIG. 12 is a fourth schematic view of the swing torque sensing and transmitting device 1D shown in FIG. 8 and mounted between the grip and the drive head, with their fitting structures corresponding to each other.

FIG. 13 is a first schematic view of the swing torque sensing and transmitting device of the disclosure, with identical input ends and different output ends.

FIG. 14 is a second schematic view of the swing torque sensing and transmitting device of the disclosure, with identical input ends and different output ends.

FIG. 15 is a third schematic view of the swing torque sensing and transmitting device of the disclosure, with identical input ends and different output ends.

FIG. 16 is a fourth schematic view of the swing torque sensing and transmitting device of the disclosure, with identical input ends and different output ends.

FIG. 17 is a schematic view of the swing torque sensing and transmitting device of the disclosure, with its outer housings having a display unit.

FIG. 18 is a first schematic view of the swing torque sensing and transmitting device of the disclosure, illustrating its assembly.

FIG. 19 is a second schematic view of the swing torque sensing and transmitting device of the disclosure, illustrating its assembly.

FIG. 20 is a schematic view of a snap-engagement structure of the swing torque sensing and transmitting device of the disclosure and various applicable drive head adapters.

FIG. 21 is a schematic exploded view of the snap-engagement structure of the swing torque sensing and transmitting device of the disclosure.

FIG. 22 is a schematic cross-sectional view of the swing torque sensing and transmitting device of FIG. 21.

FIG. 23 is a first schematic view of the combination of the snap-engagement structure of the swing torque sensing and transmitting device of the disclosure and an applicable drive head adapter.

FIG. 24 is a second schematic view of the combination of the snap-engagement structure of the swing torque sensing and transmitting device of the disclosure and an applicable drive head adapter.

FIG. 25 is a third schematic view of the combination of the snap-engagement structure of the swing torque sensing and transmitting device of the disclosure and an applicable drive head adapter.

FIG. 26 is a fourth schematic view of the combination of the snap-engagement structure of the swing torque sensing and transmitting device of the disclosure and an applicable drive head adapter.

FIG. 27 are a schematic view and an exploded view of the combination of the input end and the output end and the sensing portion of the sensing shaft of the swing torque sensing and transmitting device of the disclosure.

FIG. 28 is a schematic view of a torque calibration device of the swing torque sensing and transmitting device of the disclosure.

FIG. 29 is a schematic view of the process flow of a torque calibration method of the swing torque sensing and transmitting device of the disclosure.

FIG. 30 is a schematic view of an angle calibration device of the swing torque sensing and transmitting device of the disclosure.

FIG. 31 is a schematic view of the process flow of an angle calibration method of the swing torque sensing and transmitting device of the disclosure.

### DETAILED DESCRIPTION OF THE INVENTION

To explain the technical features, solutions, and advantages of the disclosure and the effects achieved by the disclosure, the disclosure is depicted by accompanying drawings, illustrated by embodiments, and described below. The accompanying drawings are intended to be schematic and supplement the specification and thus are not necessarily drawn to scale and presented to show precise arrangement. Therefore, the disclosure should not be interpreted according to the ratios of accompanying drawings and arrangement relationships, thereby leading to limitations on the scope of the claims of the disclosure.

The swing torque sensing and transmitting device of the disclosure swings to apply a torque for use in tightening a bolt or a nut and is capable of sensing and transmitting a torque. The swing torque sensing and transmitting device of the disclosure is mainly applicable to a torque wrench with a changeable drive head. The swing torque sensing and transmitting device of the disclosure is described below.

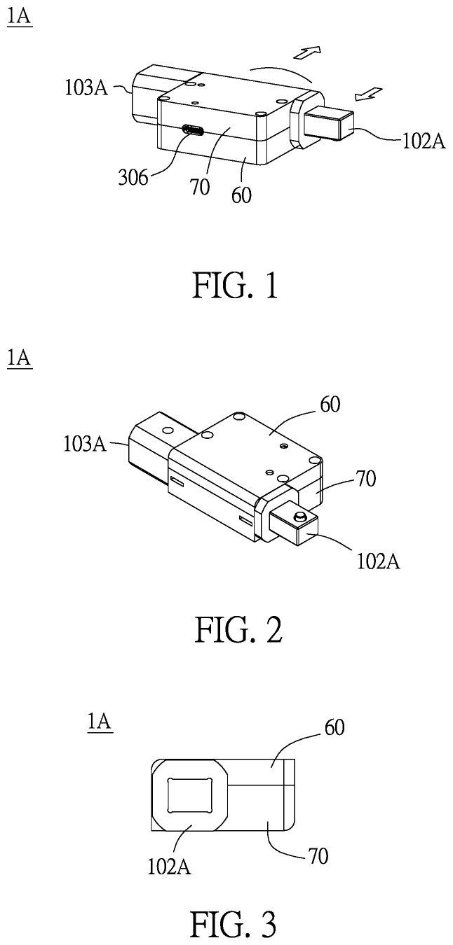

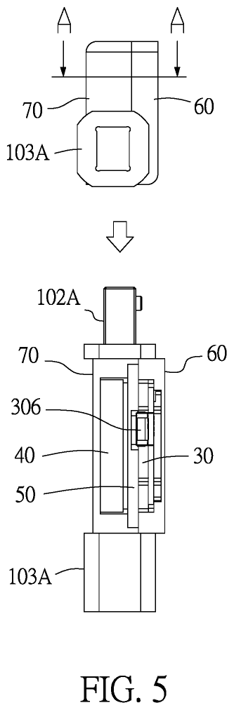

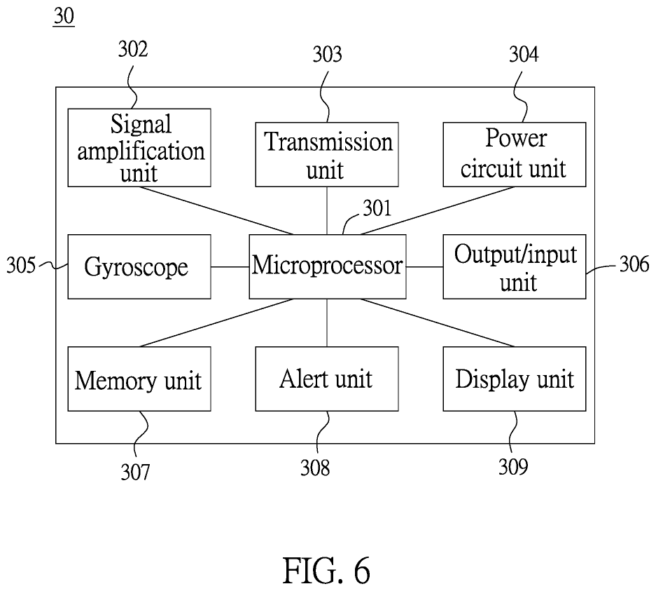

Referring to FIG. 1 through FIG. 6, a swing torque sensing and transmitting device 1A of the disclosure comprises a sensing shaft 10A. The sensing shaft 10A is a cuboid and has an output end 103A and an input end 102A. The swing torque sensing and transmitting device 1A comprises a sensing shaft 10A, a torque sensing unit 20, a circuit board module 30, a power module 40, a battery cover plate 50, a first outer housing 60 and a second outer housing 70. The sensing shaft 10A has an axis shaft whose middle segment narrows to form a sensing portion 101. The two ends of the axis shaft have an input end 102A and an output end 103A, respectively. The torque sensing unit 20 is disposed in a force-bearing direction of the sensing portion 101 and adapted to generate a deformation sensing signal in response to a bend of the sensing shaft 10A under a pulling force or a pushing force. The deformation sensing signal is processed by the circuit board module 30 to compute a real-time torque. The input end 102A of the axis shaft of the sensing shaft 10A is of a fitting structure corresponding in shape to the grip to connect to. The output end 103A of the axis shaft of the sensing shaft 10A is of a fitting structure corresponding in shape to the drive head to connect to. A first receiving chamber 601 is concavely disposed on one side of the first outer housing 60. The circuit board module 30 is fastened to a fastening screw hole in the first receiving chamber 601 of the first outer housing 60 with a bolt 80. A second receiving chamber 701 is concavely disposed on one side of the second outer housing 70. The battery module 40 is fastened to a fastening screw hole in the second receiving chamber 701 of the second outer housing 70 with a bolt 80 and the battery cover plate 50. Both the torque sensing unit 20 and the battery module 40 are electrically connected to the circuit board module 30. Finally, the first outer housing 60 and the second outer housing 70 are fastened together with a bolt 90. The circuit board module 30 illustrated by FIG. 6 comprises a microprocessor 301, a signal amplification unit 302, a transmission unit 303, a power circuit unit 304, a gyroscope 305, an output/input unit 306, a memory unit 307, an alert unit 308 and a display unit 309. The circuit board module 30 transmits the torque and an angle sensing value wired or wirelessly. During the fastening process, the gyroscope 305 surrounds a fastened object and generates a sensing signal to be processed by the microprocessor 301 to compute angular displacement. After the swing torque sensing and transmitting device 1A of the disclosure has been fitted to the grip and the drive head, calibration of the torque and the angular displacement with a torque meter and an angle gauge occurs beforehand, respectively, followed by storage of calibration parameters and code numbers of the grip and the drive head for use in operation.

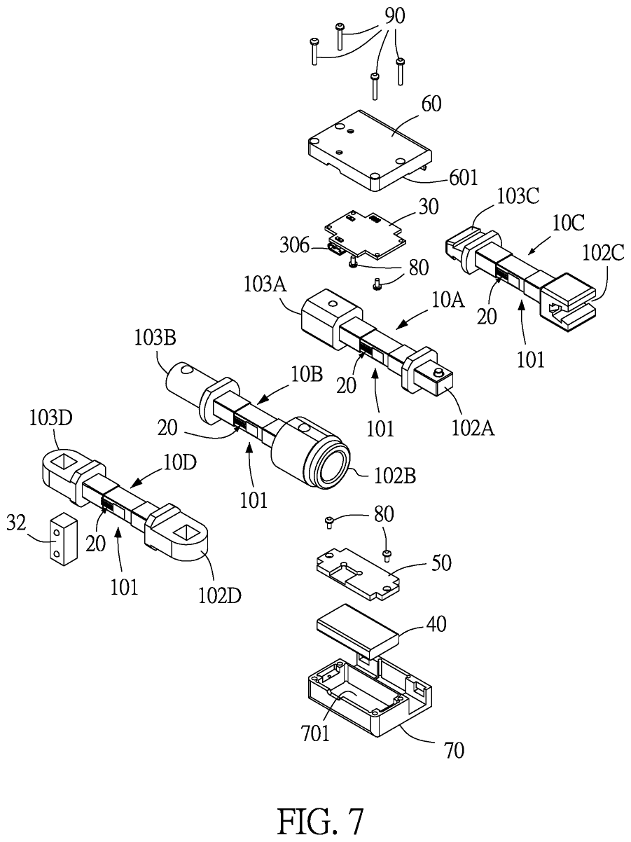

Referring to FIG. 7, modularization of the swing torque sensing and transmitting device of the disclosure requires the first outer housing 60 and the second outer housing 70 to enclose the sensing portion 101 of one of the sensing shafts 10A˜10D. The internal structure and dimensions of the sensing portion 101 are designed according to different torque sensing capability ranges, and thus the sensing portion 101 can be made of metallic materials that vary in texture or rigidity. The fitting structures of the input ends 102A˜102D and the output ends 103A˜103D correspond in shape and dimensions to the fitting structures of the grip and the drive head, respectively. The input ends 102A˜102D and the output ends 103A˜103D are of integrally formed fitting structures of the same shape and dimensions. Referring to FIG. 7, the fitting structures of the sensing shafts 10A˜10D are integrally formed and connected to the grip and the drive head with different fitting structures, respectively. The swing torque sensing and transmitting device of the disclosure functions as a sensing device that detects a torque with a pushing force or a pulling force. The input ends 102A-102D are detachably connected to an output axle of the torque tool. The output ends 103A˜103D are detachably connected to the input end of the drive head. As shown in FIG. 7, all components except for the sensing shafts 10A˜10D are identical to facilitate implementation of modularization.

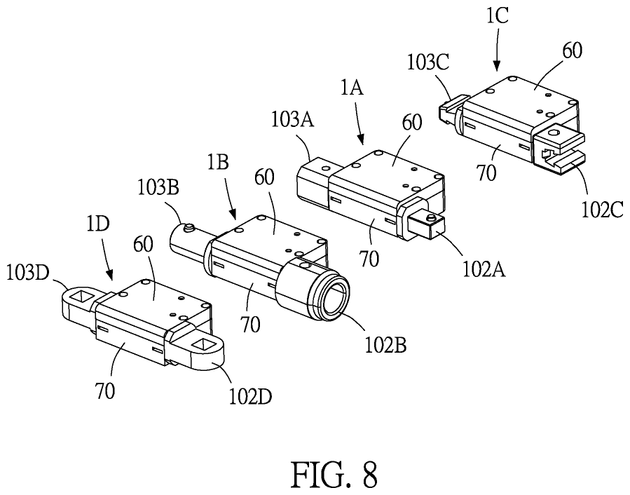

Referring to FIG. 7 and FIG. 8, there are shown schematic views of several types of standard fitting structures of the swing torque sensing and transmitting device of the disclosure. The sensing portions 101 at the narrowed portions of the middle segments of the sensing shafts 10A˜10D are identical. Within the same torque sensing capability range, the torque sensing unit 20 and other components are identical except for the shape and dimensions of the fitting structures at the two ends. Thus, an integrally formed torque sensing and transmitting device, such as the swing torque sensing and transmitting device 1A with cuboid fitting structures, can be manufactured through modularization. On the other hand, the swing torque sensing and transmitting devices 1B˜1D are integrally formed torque sensing and transmitting devices with input end and output end fitting structures in different shapes.

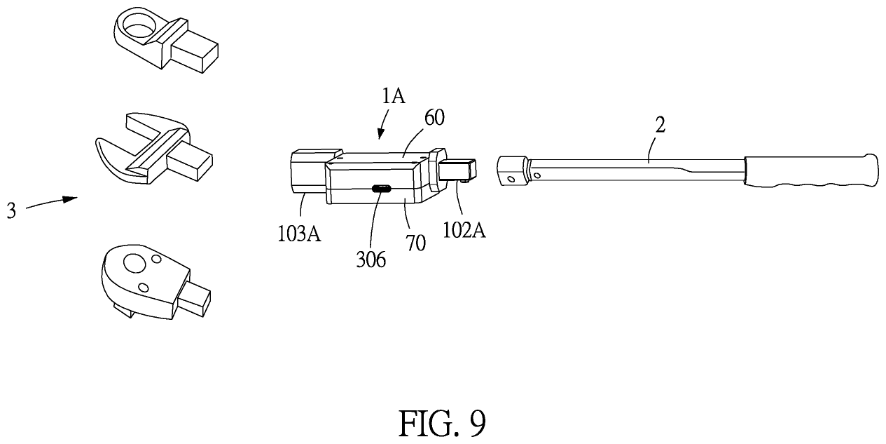

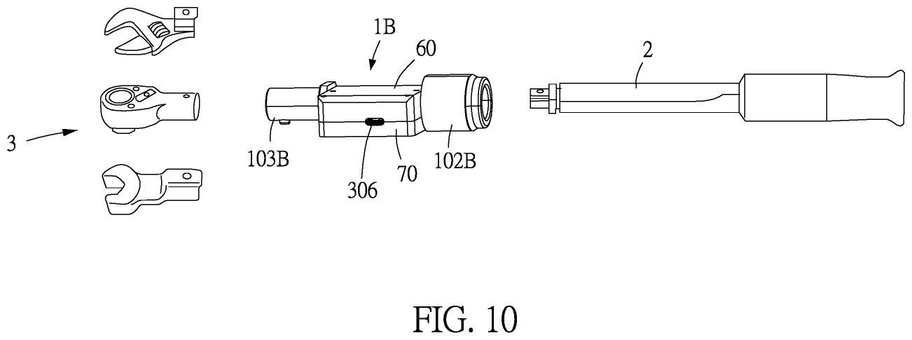

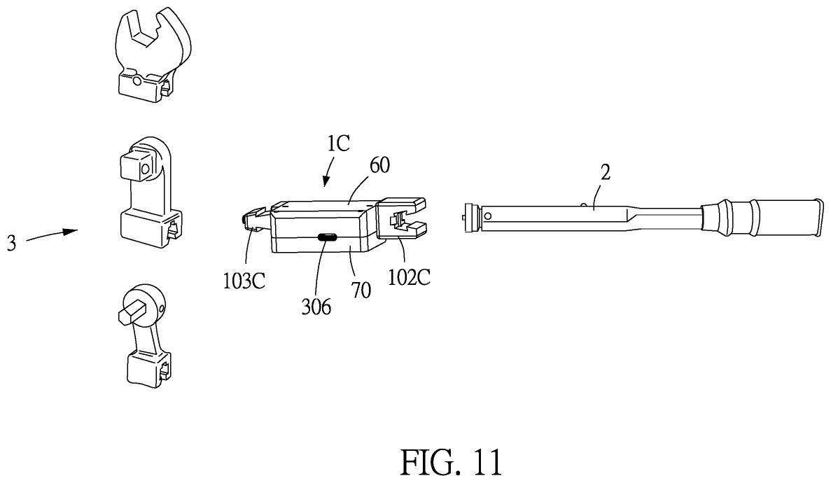

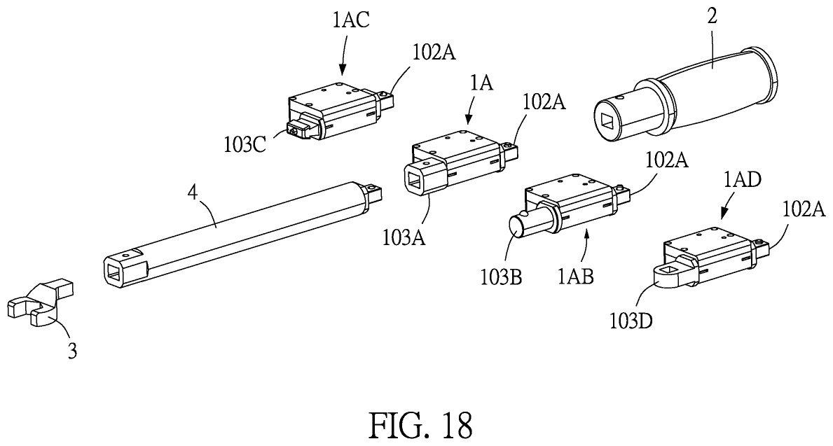

Referring to FIG. 9 through FIG. 12 and FIG. 18, there are shown schematic views of the swing torque sensing and transmitting device connected to a grip 2 and a drive head 3, with corresponding fitting structures. The cross section of the input end 102A in FIG. 9 is rectangular in shape. The cross section of the input end 102B in FIG. 10 is round in shape. The cross section of the input end 102C in FIG. 11 is dovetail-shaped. FIG. 12 shows that the cuboid head of the swing torque sensing and transmitting device 1AD of FIG. 18 is inserted into an oblong hole at the front end of the grip 2, and then a square axle 32 shown at the lower left corner of FIG. 7 passes through a square hole of the output end 103D of the swing torque sensing and transmitting device 1AD to connect to a drive head adapter 31 and the drive head 3 (shown on the left side in FIG. 12) of different shapes to thereby change the fastening direction.

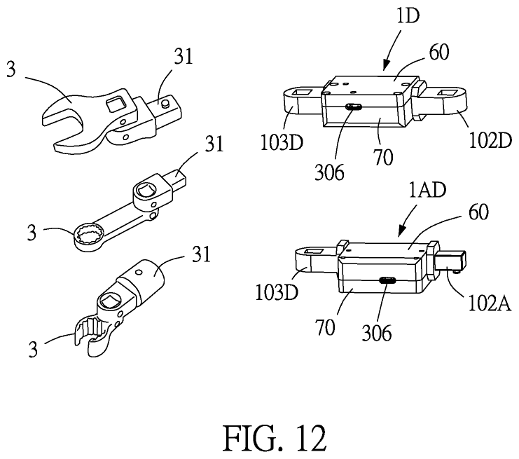

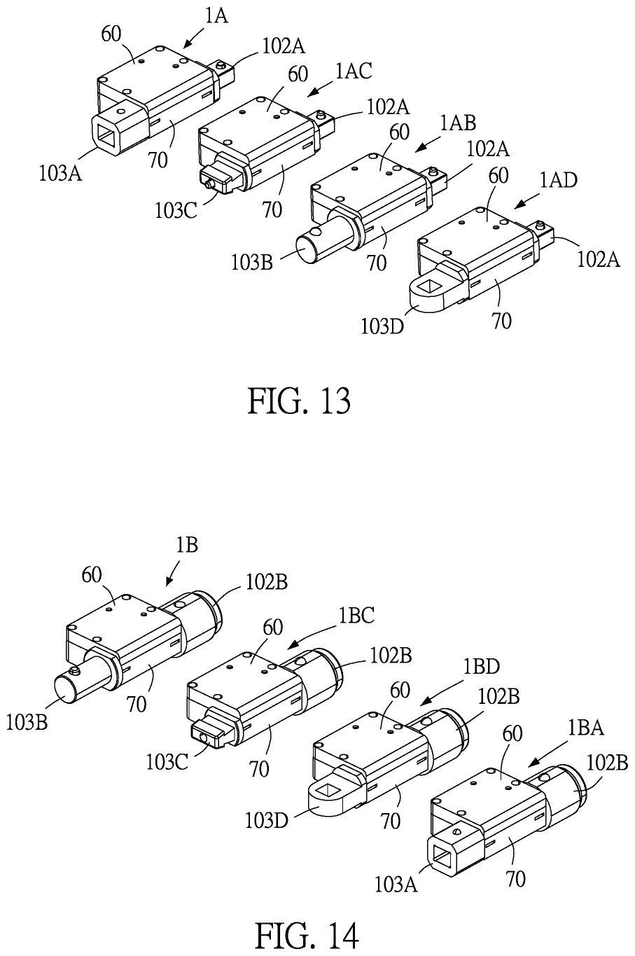

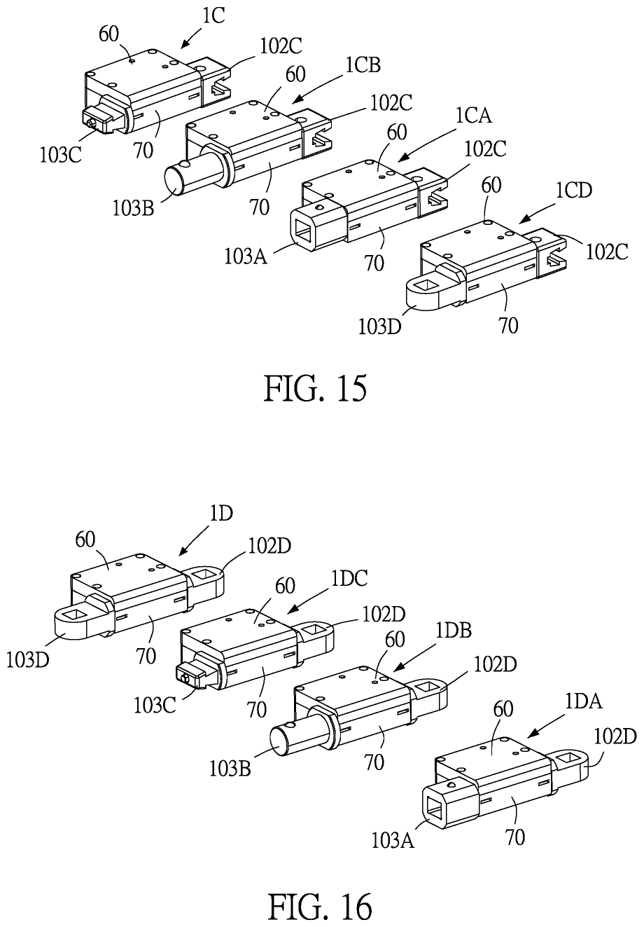

Referring to FIG. 13 through FIG. 16, within its specific torque sensing capability range, the swing torque sensing and transmitting device of the disclosure is modularized so that the identical input end 102A, 102B, 102C or 102D operates in conjunction with the output end 103A, 103B, 103C or 103D, respectively, so as for the grip with a specific fitting structure to use the drive head with another fitting structure through the device of the disclosure. Thus, fitting structures which are integrally formed but are of different shapes and dimensions are disposed between the input ends 102A˜102D and the output ends 103A˜103D, respectively.

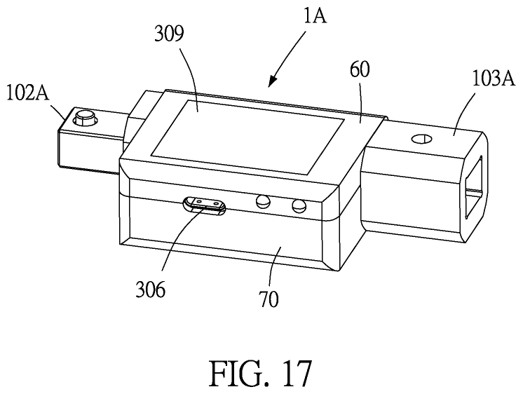

Referring to FIG. 17, the schematic view shows that the outer housings of the swing torque sensing and transmitting device of the disclosure have a display unit 309 (display screen). Data collected by the device of the disclosure can also be transmitted via a wireless transmission unit to a peripheral display device for display or storage.

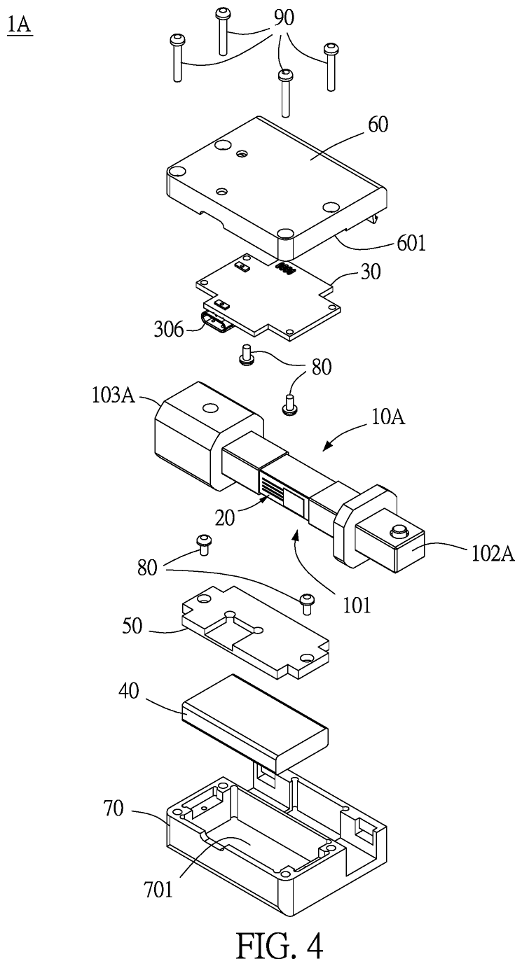

Referring to FIG. 18, there is shown another schematic view of the assembly and application of the swing torque sensing and transmitting device of the disclosure. For example, the input end 102A of FIG. 13 can be inserted into the grip 2 with a corresponding output end fitting structure, and then the output end 103A of the sensing shaft 10A of the swing torque sensing and transmitting device 1A of FIG. 4 is connected to an input end of an extension rod 4 with the same fitting structure, and finally an output end of the extension rod 4 is connected to the input end of the drive head 3 with an identical cuboid fitting structure. Thus, the device of the disclosure demonstrates enhanced use flexibility by allowing users to select the drive heads with different fitting structures because of variation in the fitting structures of an input end and an output end.

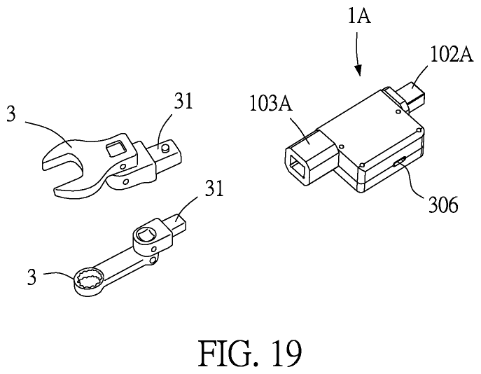

Referring to FIG. 19, there is shown another schematic view of the assembly and application of the swing torque sensing and transmitting device of the disclosure. FIG. 19 shows that the output end 103A of the sensing shaft 10A of the swing torque sensing and transmitting device 1A of FIG. 13 is connected to the drive head adapter 31 with an identical cuboid fitting structure, and then the square axle 32 of FIG. 7 connects the extension devices extending in different vertical directions.

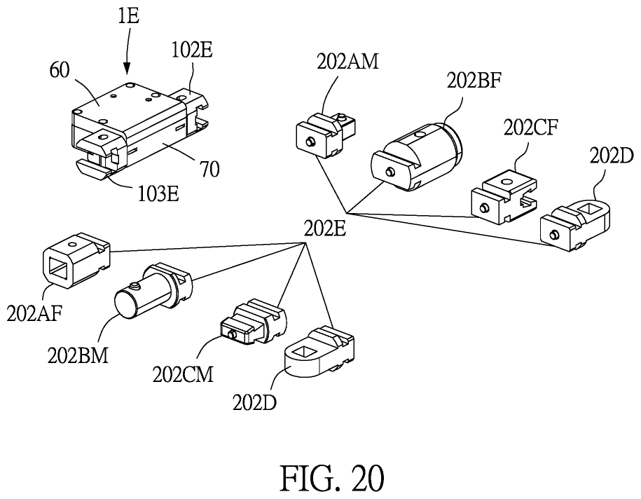

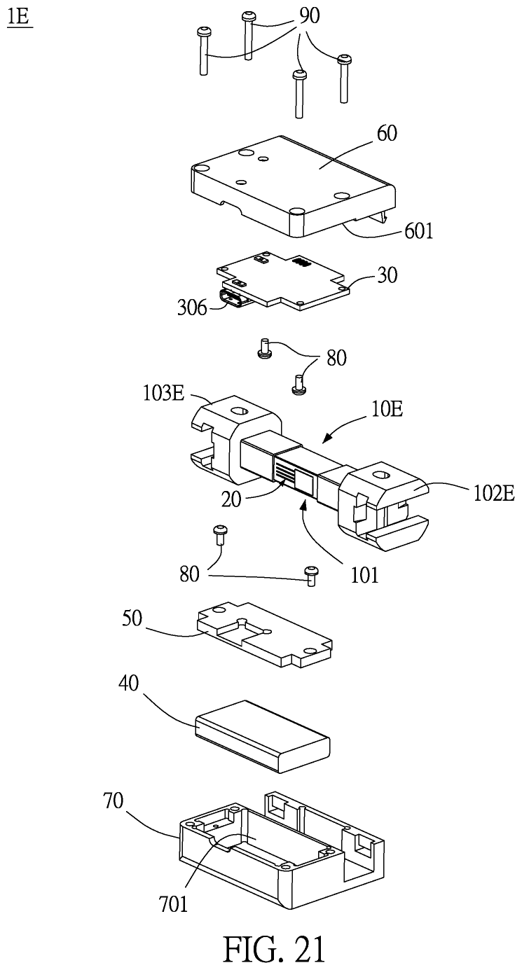

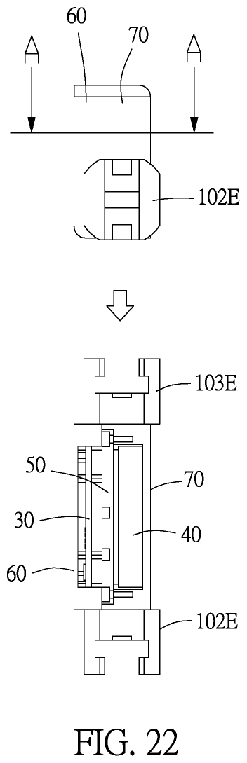

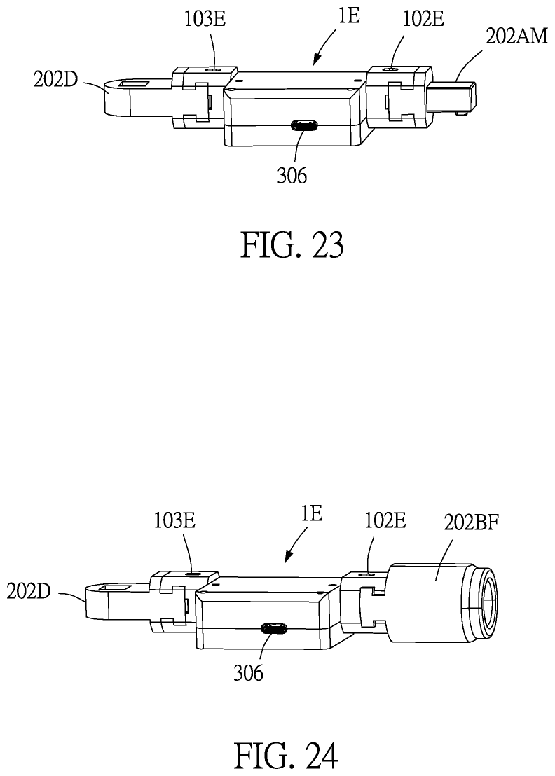

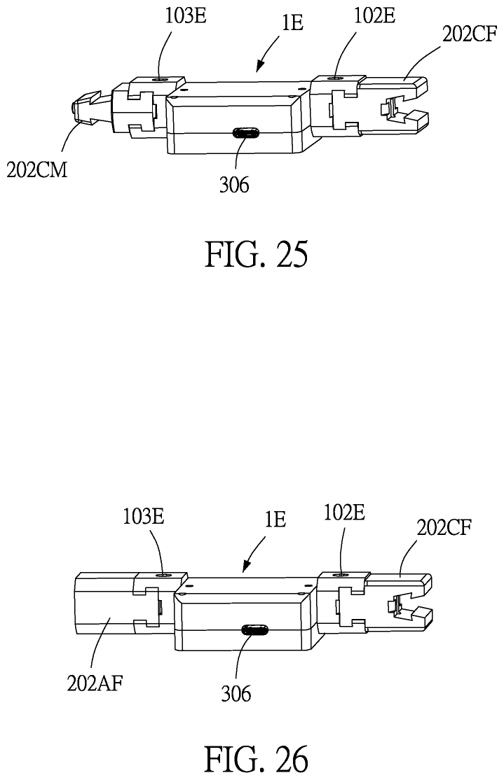

Referring to FIG. 20 through FIG. 22, there are shown a schematic view, an exploded view and a schematic cross-sectional view of another modularization structure of the swing torque sensing and transmitting device operating in conjunction with various drive head adapters according to the disclosure. In this embodiment, the sensing shaft 10E of the swing torque sensing and transmitting device 1E is modularized to the same extent as the sensing shafts 10A˜10D. The same snap-engagement mechanism of the input end 102E and output end 103E of the sensing shaft 10E enables the users to select at will various drive head adapters at the two ends of the swing torque sensing and transmitting device 1E shown in FIG. 20. The drive head adapters 202AM, 202AF, 202BM, 202BF, 202CM, 202CF, 202D can be inserted into the input end 102E and the output end 103E at the two ends of the sensing shaft 10E of the swing torque sensing and transmitting device 1E in this embodiment with the same adapter plug 202E, respectively, to connect to the grip or the drive head with identical fitting structures easily. Referring to FIG. 23 through FIG. 26, there are shown schematic views of the combinations of the snap-engagement input end and output end structure of the swing torque sensing and transmitting device of the disclosure and an applicable drive head adapter. Furthermore, the swing torque sensing and transmitting device of the disclosure can also come with a snap-engagement output end structure, and its input end is of an integrally formed fitting structure.

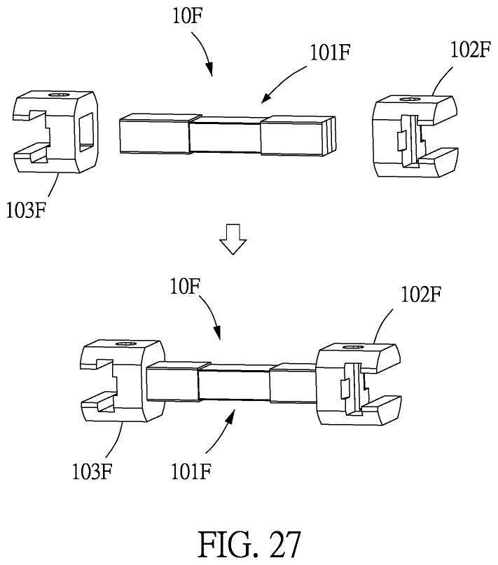

Referring to FIG. 27, the diagrams depict the sensing shaft of the swing torque sensing and transmitting device of the disclosure. Take the snap-engagement sensing shaft 10F as an example, considering the necessity of maintaining sufficient mechanical strength of the input end 102F and the output end 103F of the sensing shaft 10F, the need to share components, such as outer housings, through modularization and sense a narrow torque range requires the sensing portion 101F of the axis shaft to be made of low-strength steel alloys or aluminum alloys and then pressed against the input end 102F and output end 103F so as to be fitted together.

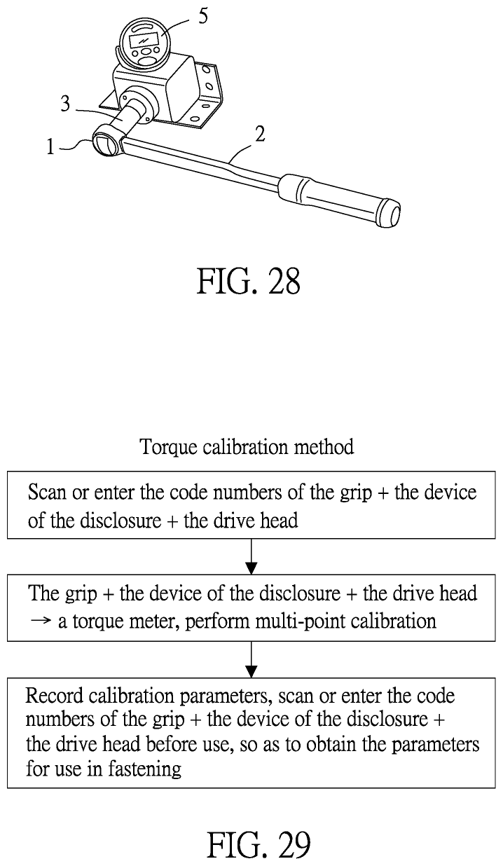

Referring to FIG. 28 and FIG. 29, there are shown schematic views of a torque calibration method of the swing torque sensing and transmitting device of the disclosure. To facilitate usage and management, the users scan or enter the code numbers of the grip 2 of a torque tool, the swing torque sensing and transmitting device 1 of the disclosure and the drive head 3 selected, then perform multi-point calibration with a torque meter 5, and finally record parameters obtained through calibration. Before starting to use the device of the disclosure, the users scan or enter the code numbers of the grip, the device of the disclosure and the drive head, so as to obtain the parameters for use in fastening.

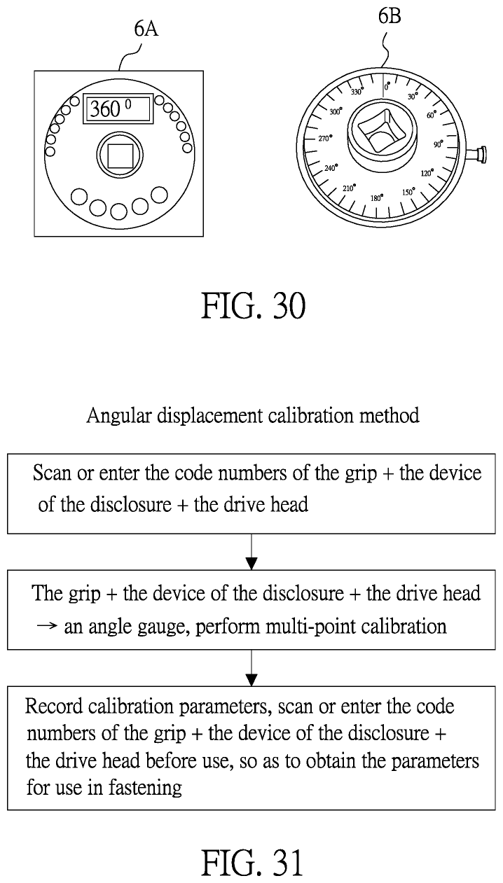

Referring to FIG. 30 and FIG. 31, there are shown schematic views of an angle calibration method of the swing torque sensing and transmitting device of the disclosure. To facilitate usage and management, the users scan or enter the code numbers of the grip of a torque tool, the device of the disclosure and the drive head selected, then perform multi-point calibration with an electronic angle gauge 6A or a mechanical angle gauge 6B, and finally record parameters obtained through calibration. Before starting to use the device of the disclosure, the users scan or enter the code numbers of the grip, the device of the disclosure and the drive head, so as to obtain the parameters for use in fastening.

Referring to the above description, the disclosure further provides a method of modularizing a swing torque sensing and transmitting device. Referring to FIG. 7 and FIG. 13 through FIG. 16, the modularization method entails sensing a torque limit according to the sensing shafts 10A˜10D and designing the dimensions of the first outer housing 60 and second outer housing 70 according to the dimensions of the circuit board module 30, battery module 40 and battery cover plate 50. The dimensions of the sensing shafts 10A˜10D and the first outer housing 60 and second outer housing 70 depend on the torque sensing capability range. The sensing shafts 10A˜10D are each equipped with the torque sensing unit 20 to transmit a deformation sensing signal outward. There are different torque sensing capability ranges below the torque limit. Each torque sensing range is dedicated to the sensing shafts of the same texture and dimensions, and only the torque sensing range for the input end and output end of the axis shaft of the sensing shaft varies and depends on the fitting structures of the grip and the drive head to connect to. The first outer housing 60, second outer housing 70, torque sensing unit 20, circuit board module 30, battery module 40, and battery cover plate 50 are identical and manufactured by modularization. To manufacture a swing torque sensing and transmitting device with a wide torque sensing capability range, it is only necessary to change the texture and dimensions of the sensing shaft and the fitting structures of the input end and output end of the axis shaft but share the other components. Therefore, the structure design of the disclosure can be simplified through modularization to manufacture a swing torque sensing and transmitting device with various torque sensing capability and thereby effectively reduce the cost incurred in procurement, production and material storage.

The invention is disclosed above by preferred embodiments. However, persons skilled in the art should understand that the embodiments are illustrative of the invention only, but shall not be interpreted as restrictive of the scope of the invention. Hence, all equivalent modifications and replacements made to the embodiments shall be deemed falling within the scope of the claims of the invention. Accordingly, the legal protection for the invention shall be defined by the appended claims.

What is claimed is:

1. A swing torque sensing and transmitting device detachably fitted between a grip and a drive head, comprising:
a sensing shaft having an axis shaft with a middle segment narrowed to form a sensing portion, wherein two ends of the axis shaft have an input end and an output end, respectively;
a torque sensing unit disposed in a force-bearing direction of the sensing portion, electrically connected to a circuit board module, and adapted to generate a deformation sensing signal in response to a bend of the sensing shaft under a pulling force or a pushing force, the deformation sensing signal being processed by the circuit board module to compute a torque;
a first outer housing with a side being concave and thereby having a first receiving chamber, the first receiving chamber having a fastening screw hole for fastening the circuit board module in place; and
a second outer housing with a side being concave and thereby having a second receiving chamber, the second receiving chamber having a fastening screw hole for fastening a battery cover plate and a battery module in place, the battery module being electrically connected to the circuit board module.

2. The swing torque sensing and transmitting device of claim 1, wherein the input end is detachably connected to an output axle of a torque tool, and the output end is detachably connected to an input end of the drive head, thereby allowing a torque to be detected with a pushing force or a pulling force.

3. The swing torque sensing and transmitting device of claim 1, wherein the sensing shaft is integrally formed or assembled according to shapes and dimensions of fitting structures of the grip or the drive head to connect to and a torque sensing capability range and operates together with dedicated said first outer housing, dedicated said second outer housing, dedicated said torque sensing unit, dedicated said circuit board module, dedicated said battery cover plate and dedicated said battery module.

4. The swing torque sensing and transmitting device of claim 1, wherein the input end and the output end of the sensing shaft have fitting structures corresponding in shapes and dimensions to the grip or the drive head, and the fitting structures of the input end and the output end are either integrally formed and identical in shapes and dimensions or integrally formed but different in shapes and dimensions.

5. The swing torque sensing and transmitting device of claim 1, wherein the input end and the output end of the sensing shaft have snap-engagement structures for operating in conjunction with drive head adapter plugs of drive head adapters to connect to the drive head and the grip with different fitting structures; or the sensing shaft and the input end are integrally formed structure, and the sensing shaft and the output end are snap-engagement structure.

6. The swing torque sensing and transmitting device of claim 1, wherein the sensing portion of the sensing shaft is made of the same material and integrally formed or is made of different materials and composite, such that the sensing shafts which differ in torque sensing capability are enclosed by the first outer housing and the second outer housing of the same dimensions.

7. The swing torque sensing and transmitting device of claim 1, wherein the circuit board module comprises a microprocessor, a signal amplification unit, a transmission unit, a power circuit unit, a gyroscope, an output/input unit, a memory unit, an alert unit and a display unit.

8. The swing torque sensing and transmitting device of claim 7, wherein the circuit board module transmits sensing data wired or wirelessly.

9. The swing torque sensing and transmitting device of claim 1, wherein, after the grip and the drive head have been fitted together, the torque is calibrated with a torque meter so that the calibrated torque is stored together with calibration parameters and code numbers of the grip and the drive head for future use.

10. The swing torque sensing and transmitting device of claim 1, wherein, after the grip and the drive head have been fitted together, an angular displacement is calibrated with an angle gauge so that the calibrated angular displacement is stored together with calibration parameters and code numbers of the grip and the drive head for future use.
